(19) United States
(12) Patent Application Publication
(10) Pub. No.: US 2005/0230370 A1
(43) Pub. Date: Oct. 20, 2005

(54) Laser beam machining equipment and method for machining by using laser beam

(75) Inventors: Michio Kameyama, Toyota-city (JP); Sumitomo Inomata, Toyota-city (JP); Eiji Kumagai, Okazaki-city (JP); Tetsuaki Kamiya, Nagoya-city (JP); Takashi Ogata, Anjo-city (JP); Tsuyoshi Hayakawa, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/091,761

(22) Filed: Mar. 29, 2005

(30) Foreign Application Priority Data
Apr. 15, 2004 (JP) 2004-120538
Feb. 14, 2005 (JP) 2005-36713

(51) Int. Cl. B23K 26/00

(52) U.S. Cl. 219/121.72; 235/462.46

(57) ABSTRACT

A method for machining an object includes the steps of: forming a hole in the object by a laser beam having a first focus point; and reforming the hole by the laser beam having a second focus point, which is different from the first focus point. The first and the second focus points are disposed on a same light axis. In at least one of the step of forming the hole and the step of reforming the hole, the object is machined by a diffusion and a condensation of the laser beam in the object.

### CROSS REFERENCE TO RELATED APPLICATIONS

This application is based on Japanese Patent Applications No. 2004-120538 filed on Apr. 15, 2004, and No. 2005-36713 filed on Feb. 14, 2005, the disclosures of which are incorporated herein by reference.

### FIELD OF THE INVENTION

The present invention relates to laser beam machining equipment and a method for machining by using laser beam.

### BACKGROUND OF THE INVENTION

A laser beam machining method is disclosed in, for example, Japanese Patent Application Publication No. S58-38689. The method is such that an object is irradiated with a laser beam, which is focused on the object by an optical system such as an object lens and the like, so that a part of the material of the object is evaporated and removed so that the object is machined. In this method, the focus of the laser beam is positioned on a predetermined position of the object. Here, the focus is a point, which has the maximum energy density. Thus, the predetermined position of the object is evaporated and removed. Then, the focus is shifted so that the predetermined position of the object is also displaced, and the object is machined, i.e., cut or drilled.

However, in the above method, a condenser lens is shifted up and down so that the focusing position is shifted. Therefore, when the laser beam is focused on a lower side of the object for machining the lower side of the object, the laser beam having a comparatively large energy density is absorbed on an upper side of the object in a large area of the object with a defocusing state of the laser beam. Accordingly, the upper side of the object, which is a part not to be machined, may be also evaporated and removed. Therefore, for example, a periphery of a through-hole to be machined is formed to be a tapered shape. Thus, an opening of the through-hole is tapered from a lower side to an upper side. Thus, the positioning accuracy and the machining accuracy of the through-hole is reduced.

To improve the above defocusing, another laser beam machining method is disclosed in, for example, Japanese Patent Application Publication NO. 2002-239769. In this method, when the focusing position of the laser beam is shifted from the upper side of the object to the lower side, an expanding angle of the laser beam becomes larger. The expanding angle has a vertex as the focusing position. Specifically, the focusing position is moved in a thickness direction of the object so that the expanding angle becomes larger. Accordingly, when the lower side of the object is machined with the laser beam, the energy density of the laser beam, which is defocused on the upper side of the object, can be reduced. Therefore, the upper side of the object is not substantially evaporated; and therefore, only the lower side of the object, which is to be machined, is evaporated and removed. Thus, the machining accuracy of the method is improved.

However, in the above method, the focusing position is continuously shifted so that the through-hole or the like is formed in the object in one process. Therefore, the focusing position of the laser beam may be shifted before the to-be-machined position of the object is completely evaporated and removed. In this case, the machining accuracy of the method is reduced.

### SUMMARY OF THE INVENTION

In view of the above-described problem, it is an object of the present invention to provide laser beam machining equipment having high machining accuracy and a method for machining by using a laser beam with high machining accuracy.

A method for machining an object includes the steps of: forming a hole in the object by a laser beam in such a manner that the laser beam has a first focus point; and reforming the hole by the laser beam in such a manner that the laser beam has a second focus point, which is different from the first focus point. The first and the second focus points are disposed on a same light axis. In at least one of the step of forming the hole and the step of reforming the hole, the object is machined by a diffusion and a condensation of the laser beam in the object. The condensation is performed by reflection of the laser beam reflected on an inner wall of the hole.

By the above method, the object is machined with high machining accuracy. Specifically, the first focus point of the laser beam is changed once in the shape reform process. Thus, the difference of the width between the wide width portion and the narrow width portion is reduced. Accordingly, the hole having high straightness is obtained.

Preferably, the hole is machined to have a predetermined shape, which includes a narrow width portion and a wide width portion. The narrow width portion is formed by the laser beam switching from the condensation to the diffusion. The wide width portion is formed by the laser beam switching from the diffusion to the condensation. The narrow width portion and the wide width portion of the hole are disposed alternately in the object.

Preferably, in the step of reforming the hole, the hole is reformed multiple times with the laser beam having different focus points, which are different from the first focus point.

Further, laser beam machining equipment for forming a through-hole in an object includes: a laser beam output device for outputting a laser beam; a condenser lens for condensing the laser beam on the object; and a varifocal device for controlling a focus point of the laser beam coaxially. The varifocal device controls the laser beam to have a predetermined focus point so that a diffusion of the laser beam in the object and a condensation of the laser beam reflected on an inner wall of the through-hole are occurred for machining the through-hole having a predetermined shape. The varifocal device is capable of changing the focus point of the laser beam so that the through-hole is reformed.

The above equipment machines the object with high machining accuracy. Specifically, the focus point of the laser beam is changed once in a shape reform process. Thus, the difference of the width between the wide width portion and the narrow width portion is reduced. Accordingly, the hole having high straightness is obtained.

Preferably, the equipment further includes: a diameter controller for controlling a diameter of the laser beam outputted from the condenser lens; and an energy density controller for controlling an energy density of the laser beam. The laser beam is controlled by at least one of the diameter controller, the energy density controller and the varifocal device.

Preferably, the varifocal device changes the focus point of the laser beam a plurality of times to be different positions for reforming the through-hole.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic perspective view showing laser beam machining equipment according to a first embodiment of the present invention;

FIGS. 2A to 2E are cross sectional views showing a through-hole processed with different conditions, according to the first embodiment;

FIG. 3A is a cross sectional view showing the through-hole machined in a through-hole forming process, and FIG. 3B is a cross sectional view showing the through-hole machined in a shape reform process, according to the first embodiment;

FIG. 4A is a cross sectional view showing the through-hole machined in a through-hole forming process, and FIG. 4B is a cross sectional view showing the through-hole machined in a shape reform process, according to a comparison of the first embodiment;

FIG. 5 is a schematic view explaining a method for controlling a cross section of the through-hole, according to the first embodiment;

FIG. 6A is a cross sectional view showing a method for forming the through-hole by a laser beam having a 3 mmφ diameter, and FIG. 6B is a cross sectional view showing a method for forming the through-hole by a laser beam having a 9 mmφ diameter, according to the first embodiment;

FIG. 7 is a schematic perspective view showing laser beam machining equipment according to a second embodiment of the present invention; and

FIG. 8A is a cross sectional view showing the through-hole machined in a through-hole forming process, and FIG. 8B is a cross sectional view showing the through-hole machined in a shape reform process, according to a modification of the first embodiment.

### DETAILED DESCRIPTION OF THE PREFERRED EMBODIMENTS

### First Embodiment

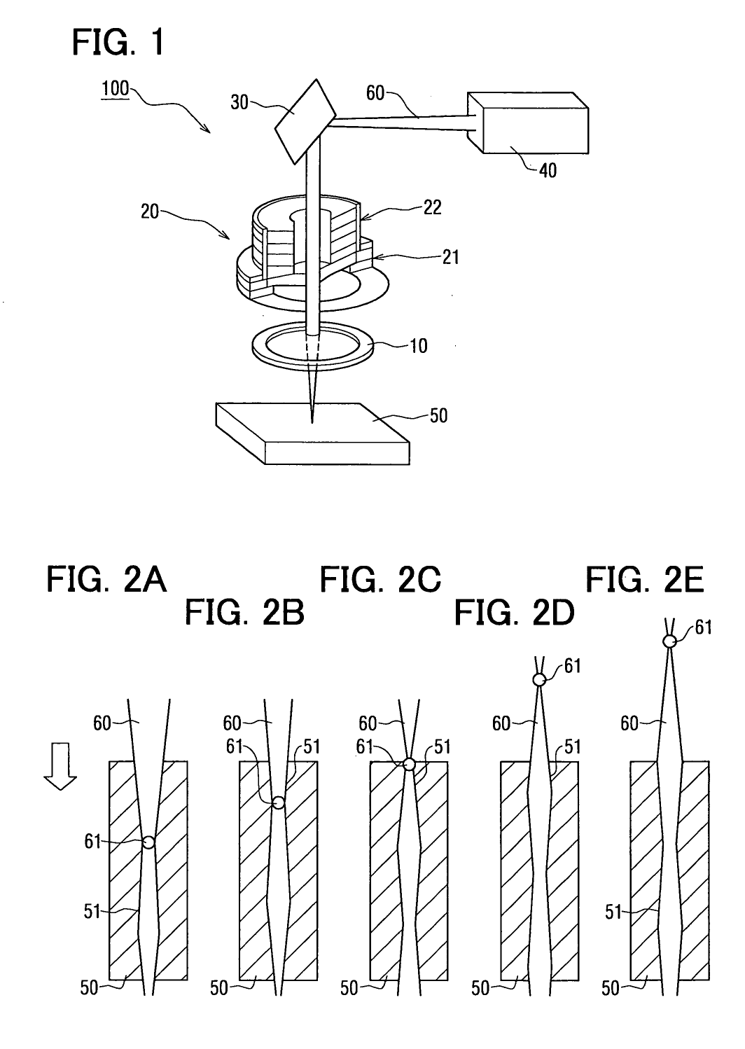

FIG. 1 shows laser beam machining equipment 100 according to a first embodiment of the present invention. The equipment 100 performs a method for machining by using a laser beam 60, according to the first embodiment. The equipment 100 machines, i.e., manufactures or drills, for example, a metallic plate 50. For example, the equipment 100 drills a predetermined through-hole in the metallic plate 50. Specifically, the equipment 100 manufactures a jet nozzle of an engine.

The equipment 100 includes a condenser lens 10, a varifocal lens device 20, a mirror 30 and a laser beam output device 40. The condenser lens 10 condenses a laser beam 60 to irradiate the laser beam 60 on an object, i.e., the metallic plate 50 to be machined. The varifocal lens device 20 is capable of changing a curvature of a lens surface so that the varifocal lens device 20 controls an incident angle of the laser beam 60 to be introduced into the condenser lens 10. The mirror 30 works as a reflection mirror. The laser beam output device 40 outputs the laser beam 60. Here, the object 50 as a to-be-machined work is disposed under the condenser lens 10. The above parts such as a condenser lens 10 are conventional parts, which is disclosed in, for example, Japanese Patent Application Publication No. 2002-239769.

The varifocal lens device 20 includes a lens portion 21 and a laminated type Piezoelectric actuator 22. The lens portion 21 controls a curvature of the lens portion 21. The actuator 22 is bonded to the lens portion 21 so that the actuator 22 actuates the curvature of the lens portion 22. An electric voltage is applied to the actuator 22. The voltage applied to the actuator 22 is controlled so that amount of variation of a Piezoelectric bimorph composing the actuator 22 is controlled. Specifically, the curvature of the lens portion 21 is controlled after the voltage is applied to the lens portion 21. Accordingly, the focus point of the laser beam is controlled.

The laser beam output device 40 outputs the laser beam 60 having a predetermined wavelength for drilling a through-hole in the object 50. The laser beam output device 40 outputs a SHG (i.e., second harmonic generation) laser as the laser beam 60. The SHG laser has a 532 nm wavelength, and is based on a primary YAG (i.e., yttrium aluminium garnet) laser having a 1064 nm wavelength. The equipment 100 can use another laser beam selected on the basis of a machining condition of the object 50 as long as a laser beam oscillator radiates the laser beam or it's harmonic generation laser.

The laser beam 60 outputted from the laser beam output device 40 is reflected with the mirror 30 toward the object 50. The, the laser beam 60 enters in the varifocal lens device 20. The laser beam 60 is outputted from the varifocal lens device 20 with a predetermined expanding angle in accordance with the curvature of the lens portion 21 in the varifocal lens device 20. Then, the laser beam 60 is condensed by the condenser lens 10 so that the laser beam 60 having a predetermined focus position is irradiated on the object 50. Thus, a part of the object 50 to be machined is evaporated and removed so that the through-hole is formed.

Here, the inventors have preliminarily studied about the laser beam machining. Specifically, the focus point of the laser beam 60 is fixed, and the laser beam 60 is irradiated on the object 50. Then, the through-hole formed in the object 50 is observed, i.e., the cross section of the through-hole in a thickness direction is observed. The SGH laser having an output power of 2 W, a frequency of 1 kHz is used. An output diameter of the laser beam 60 outputted from the condenser lens 10 is set to be 3 mmφ. The object 50 is made of chrome molybdenum steel (i.e., SCM), and the thickness of the object 50 is in a range between 0.5 mm and 1.5 mm.

A machining result of the above study is shown in FIGS. 2A to 2E. The laser beam 60 is irradiated on the object 50 along with an arrow in FIGS. 2A to 2E. The object has a 1.0 mm thickness. The surface of the object 50 is defined as a reference of the focus point 61 of the laser 60. In this case, as shown in FIG. 2C, the focus point 61 is disposed on the surface of the object 50 so that the reference position is defined as zero. FIG. 2A shows a case of the focusing position of −0.4 mm, FIG. 2B shows a case of the focusing position of −0.2 mm, FIG. 2D shows a case of the focusing position of +0.4 mm, and FIG. 2D shows a case of the focusing position of +0.6 mm.

The cross section of the through-hole 51 formed in the object 50 has at least one wide width portion. The wide width portion is formed by an expansion and a condensation of the laser beam 60 in the object 50. The expansion of the laser beam 60 is performed in the object 50, and the condensation of the laser beam 60 is performed by a reflection of an inner wall of the through-hole 51. Therefore, the laser beam 60 does not continue to expand from the focus point 61 in the object 50. But, the laser beam 60 temporarily expands in the object 50, then the energy density of the laser beam 60 is reduced so that the laser beam 60 can not evaporate and remove a part of the object 50 any more in an expanding direction, and then, the laser beam 60 is reflected on the inner wall of the through-hole 51 so that the laser beam 60 is condensed. Here, the inner wall of the through-hole 51 has a mirror surface manufactured by evaporation and removal of a part of the object 50. Here, as shown in FIG. 2C, the cross section of the through-hole 51 has not only the wide width portion but also a narrow width portion. The narrow width portion is a point, at which the cross section switches from condensation to expansion. When the focus point is set in the object 50, the focus point becomes the narrow width portion.

As shown in FIGS. 2A to 2E, the cross section of the through-hole 51 is changed in accordance with the focus position 61 in the object 50. Accordingly, the through-hole 51 is formed in the object 50 with high accuracy by using the above phenomenon of the laser beam 60.

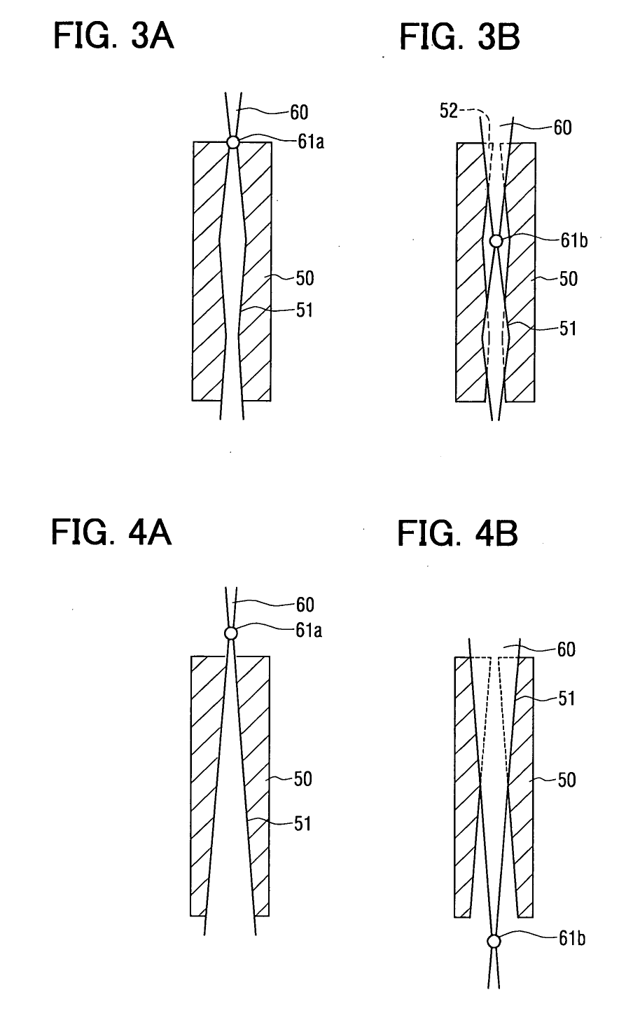

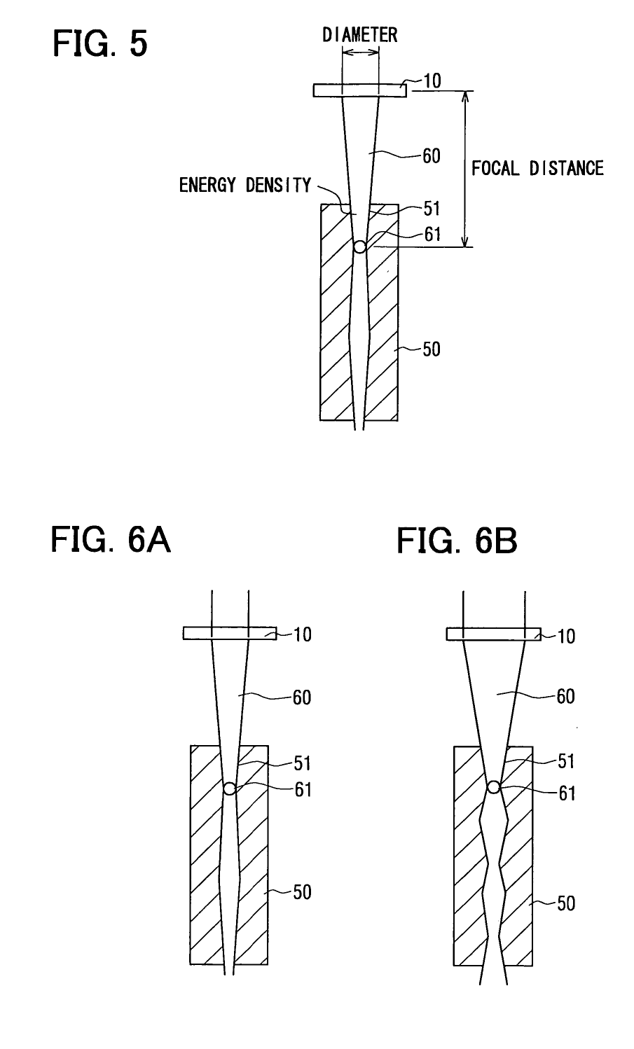

Next, the through-hole 51 having a predetermined shape is formed in the object 50 by the laser beam machining equipment 100. Specifically, the through-hole 51 shown in FIGS. 3A and 3B has high straightness. FIG. 3A shows a through-hole forming- process, and FIG. 3B shows a shape reform process. The manufacturing condition of the method shown in FIGS. 3A and 3B is the same as that in FIGS. 2A to 2E. The through-hole 51 having a 50 μm diameter is formed in the SCM plate having a thickness of 1 mm.

Firstly, the through-hole forming process is performed so that an initial through-hole 51 is formed in the object 50. In this process, the focus point 61a of the laser beam 60 is set on the surface of the object 50, and then, the laser beam 60 is irradiated on the object 50. Thus, the through-hole 51 having at least one wide width portion is formed in the object 50. In FIG. 3A, the through-hole 51 has not only the wide width portion but also the narrow width portion. Thus, the through-hole 51 has a predetermined shape having the wide and the narrow width portions. Since the difference of the width between the wide width portion and the narrow width portion is large, the laser beam 60 is irradiated on the object 50 again for reducing the difference of the width of the through-hole 51. Specifically, excess portion 52 is removed by the laser beam 60. Thus, the shape reform process for reforming the shape of the through-hole 51 to be a predetermined shape is performed. Specifically, the through-hole 51 is arranged in shape to have high straightness. The laser beam axis of the laser beam 60 in the shape reform process is almost the same as that in the through-hole forming process. The focus position 61b in the shape reform process is shifted from the focus position 61a in the through-hole forming process by about 0.4 mm deeper from the surface of the object 50. Then, the laser beam 60 is irradiated on the object 50. Thus, the through-hole 51 is reformed and arranged to have a predetermined shape. Specifically, the laser beam 60 in the shape reform process has a narrow-wide laser beam pattern in the object 50, which is different from that in the through-hole forming process. The pattern in the shape reform process is shifted in the thickness direction from that in the through-hole forming process. Thus, the difference between the wide width portion and the narrow width portion of the through-hole 51 becomes smaller. The focus point is shifted by controlling the voltage applied to the varifocal lens device 20. In this case, the object 50 is fixed in it's position. When the laser beam 60 turns off temporarily, the focus position 61 of the laser beam 60 is shifted. However, the focus position 61 can be shifted from the point 61a to the point 61b with irradiating the laser beam 60 on the object 50. In this case, it is required for the laser beam 60 not to machine the object 50 during the focus point 61 is changed.

Thus, in the method for machining the object 50 according to the first embodiment, the focus point 61 of the laser beam 60 is changed in each process so that the object 50 is machined to be a predetermined pattern having the wide and the narrow width portions. Thus, the machining pattern in each process is overlapped finally so that the through-hoe 51 is formed to be a predetermined shape. Accordingly, the method of the first embodiment can perform to machine the object 50 with high machining accuracy, compared with a conventional method for machining an object. The conventional method is such that the focus position of the laser beam is continuously changed.

The shift distance of the focus position is in a range of one pitch between neighboring wide width portions or neighboring narrow width portions. Here, in the method shown in FIGS. 4A and 4B, the focus point 61a is set to be disposed over the object 50 made of, for example, a printed circuit board so that the through-hole 51 is preliminarily formed in the object 50, and then, the focus point 61b is shifted from the upper side of the object 50 to the lower side of the object 50 so that the trough-hole is reformed. In this case, the displacement distance of the focus point 61 is long, and further, the difference of the width in the through-hole 51 is not reduced substantially. Therefore, the machining accuracy of the method shown in FIGS. 4A and 4B is not sufficient.

However, in the method according to the first embodiment, firstly, at least one wide width portion is formed in the through-hole 51. Therefore, the displacement distance of the focus point 61 becomes shorter. Accordingly, the through-hole having a predetermined shape is formed in a time efficient manner. Further, after the through-hole is preliminarily formed, the focus point 61b is shifted to form another predetermined patter of the through-hole 51 having at least one narrow width so that the through-hole 51 having high straightness is provided.

The process for forming the through-hole 51 having at least one wide width portion depends on the material of the object 50, the thickness of the object 50, the wavelength of the laser beam 60 and the like. Specifically, as shown in FIGS. 6A and 6B, by controlling at least one condition among the diameter of the laser beam 60 outputted from the condenser lens 10, the focal distance between the condenser lens 10 and the focus point 61 and the energy density of the laser beam 60, the shape of the through-hole 51, i.e., the cross section of the through-hole 51 can be controlled. In FIG. 6A, the diameter of the laser beam 60 is 3 mmφ, and in FIG. 6B, the diameter of the laser beam 60 is 9 mmφ. Here, FIG. 6A corresponds to FIG. 2B.

The distance between the wide width portion and the narrow width portion in the through-hole 51 formed by a process shown in FIG. 6B is shorter than that shown in FIG. 6A. Therefore, the total number of the wide width portion and the narrow width portion in the through-hole 51 shown in FIG. 6B is larger than that shown in FIG. 6A. This is because the focusing angle of the laser beam 60 becomes larger as the diameter of the laser beam 60 is large. Therefore, the diffusion angle of the laser beam 60 in the object 50 becomes larger so that a distance of the reflection in the object 50 becomes shorter. Specifically, the energy density of the laser beam 60 is reduced within a short distance in the object 50 so that the laser beam 60 is reflected on the inner wall of the through-hole 51, and therefore, the laser beam is changed from the diffusion to the condensation in the object 50 with the short distance.

Similarly, the condensation angle becomes smaller as the focal distance becomes long. Thus, in this case, the distance between the wide width portion and the narrow width portion becomes longer. Further, the distance between the wide width portion and the narrow width portion becomes longer, as the energy density of the laser beam 60 becomes higher. This is because the thermal energy absorbed in the object 50 becomes higher when the energy density is high, so that the melting range of the object 50 expands in the radial direction. Thus, the diameter of the through-hole 51 becomes larger so that the distance between the wide width portion and the narrow width portion becomes longer. Here, if the energy density of the laser beam 60 becomes much higher, the laser beam 60 continue to diffuse in the object 50 without reflecting on the inner wall of the through-hole 50. For example, when the output power of the laser beam 60 is 4 Watts, the wide width portion is not formed in the through-hole 50, so that the cross section of the through-hole 50 becomes a horn shape. Specifically, the laser beam 60 is diffused from the focus point 61 without condensing in the object 50.

Thus, by controlling at least one condition among the diameter of the laser beam 60, the focal distance between the condenser lens 10 and the focus point 61 and the energy density of the laser beam 60, the cross section of the through-hole 51 is controlled effectively. Further, by controlling all of conditions of the diameter, the focal distance and the energy density appropriately, the cross section of the through-hole 51 can be controlled with high accuracy. For example, in the shape reform process, the focus point 61 of the laser beam 60 and the energy density of the laser beam 60 are changed simultaneously so that the cross section of the through-hole 51 is controlled appropriately. In the first embodiment, the laser beam machining equipment 100 has the varifocal lens device 20 so that the expanding angle of the laser beam 60 outputted from the varifocal lens device 20 is controlled. Thus, the energy density of the laser beam 60 and the diameter of the laser beam 60 outputted from the condenser lens 10 are controlled appropriately with high accuracy. Accordingly, the shape of the through-hole 51 is controlled with high accuracy.

Preferably, as shown in FIG. 6B, the cross section of the through-hole 51 is formed to have a shape including the wide width portion and the narrow width portion, which are repeated alternately. Specifically, it is preferred that the distance between the wide width portion and the narrow width portion becomes shorter. In this case, the displacement distance of the focus point 61 can be shorter so that the through-hole 51 is effectively formed. Further, as the distance between the wide width portion and the narrow width portion becomes shorter (or the condensation angle of the laser beam 60 becomes larger), the excess portion 52 of the laser beam 60 per one pitch between the wide width portion and the narrow width portion becomes smaller. The excess portion 52 is a to-be-evaporated portion in the shape reform process for reducing the difference of the width between the wide width portion and the narrow width portion. Accordingly, the through-hole 51 is formed with high accuracy with the small number of shifting of the focus position 61. The through-hole 51 is formed in a short process time. Further, since the excess portion 52 is small, the thermal influence of the laser beam 60 is small so that the accuracy of the shape of the through-hole 51 is improved.

In the first embodiment, the focus point 61 of the laser beam 60 is changed once in the shape reform process. The focus point 61 can be changed multiple times in the shape reform process so that the through-hole 51 having high straightness is obtained. Specifically, the laser beam 60 is controlled to have different multiple focus points 61 so that the shape reform process is performed. In this case, the inner wall of the through-hole 51 becomes much straight, i.e., more smooth, so that the accuracy of the shape of the through-hole is much improved. Specifically, the difference of the width between the wide width portion and the narrow width portion is reduced.

Although the focus point 61 of the laser beam 60 is set to be in the object 50, the focus point 61 can be set to be outside of the object 50. For example, at least one time, the focus point is set to be outside of the object 50, the through-hole can be formed with high accuracy in shape of the through-hole 50 even when the thickness of the object 50 is thick.

Although the equipment 100 includes the varifocal lens device 20, the equipment 100 can include no varifocal lens device. In this case, the condenser lens 10 or the object 50 is displaced so that the focus point 61 of the laser beam 60 is controlled. Here, if the object 50 is displaced, the object 50 may be oscillated so that the machining accuracy of the object 50 may be deteriorated. Further, when the weight of the object 50 is large, or the dimensions of the object 50 are large, the equipment for displacing the object 50 becomes larger. Therefore, it is preferred that the condenser lens 10 is displaced without displacing the object 50 for displacing the focus point 61 of the laser beam 60.

Although the object 50 is made of metallic plate, the object 50 can be made of any material such as resin. Here, in the method for machining by using the laser beam 60, the condensation and the diffusion of the laser beam 60 in the object 50 are utilized. Therefore, it is preferred that the inner wall of the through-hole 51 is mirror-finished. In case of resin composing the object 50, the inner wall of the through-hole 51 is difficult to finish with a mirror surface, compared with the case of metallic plate composing the object 50. Accordingly, it is preferred that the object 50 is made of metallic material.

In the first embodiment, the varifocal lens device 20 works as an energy density controller for controlling the energy density of the laser beam 60 and a diameter of laser beam controller for controlling the diameter of the laser beam 60 outputted from the condenser lens 10. Therefore, the focus point 61 of the laser beam 60, the energy density, and the diameter of the laser beam 60 can be controlled by the varifocal lens device 20. Here, the energy density of the laser beam 60 can be controlled by the laser beam output device 40. Further, the diameter can be controlled by a beam expander and a collimator together with the condenser lens 10.

Although the equipment 100 includes the mirror 30, the equipment 200 can have no mirror 30.

Although the equipment 100 machines the through-hole 51, the equipment 100 can machine other through-holes such as a through-hole having a cylindrical shape and a through-hole having a tapered shape. Further, the equipment 100 can machine a hole having a bottom.

Although the equipment 100 machines the through-hole 51 having the wide width portion and the narrow width portion in both of the through-hole forming process and the shape reform process, in at least one of the through-hole forming process and the shape reform process, the through-hole 51 having at least one wide width portion can be formed. For example, as shown in FIG. 8A, firstly, the focus point 61a is set to be inside of the object 50, so that the cross section of the through hole 51 has the narrow width portion at the focus point 61a. Then, as shown in FIG. 8B, the focus point is shifted from the point 61a to the focus point 61b, which is disposed on the surface of the object 50, so that the cross section of the through-hole 51 has the wide width portion. Thus, the shape of the through-hole 51 is reformed in the shape reform process.

### Second Embodiment

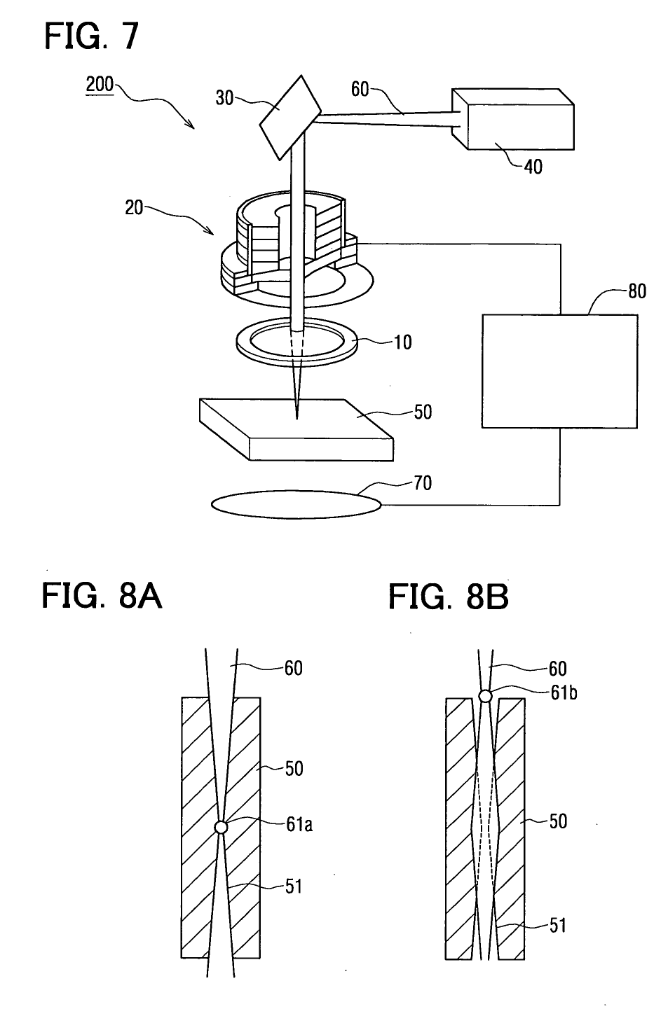

Laser beam machining equipment 200 according to a second embodiment of the present invention is shown in FIG. 7.

The equipment 200 can control the focus point 61 of the laser beam 60 automatically. The equipment 200 includes a detection portion 70 for detecting the laser beam 60 penetrating through the object 50 and a controller 80 for controlling the voltage applied to the varifocal lens device 20 on the basis of the detected laser beam 60 detected by the detection portion 70. Thus, the controller 80 controls the focus point 61 of the laser beam 60 on the same light axis on the basis of the detected laser beam 60. Accordingly, the equipment 200 has an automatic varifocal system.

The detection portion 70 can detect the laser beam 60 penetrating through the object 50 after the through-hole 51 is formed in the through-hole forming process. The detection portion 70 is formed of, for example, a photo diode. In this case, the equipment 200 has a simple construction. However, the photo diode does not detect the displacement of the focus position 61 of the laser beam 60. Therefore, the focus point 61 can not be controlled automatically even when it is necessary for the focus point 51 to displace another point after the through-hole 51 is formed in the object 50. However, in this case, the controller 80 controls the laser beam output device 40 to radiate the laser beam 60 in a predetermined interval. Thus, even after the through-hole 51 is formed, the focus point 61 of the laser beam 60 can be controlled on the basis of the detection of the laser beam 60 detected by the detection portion 70.

Further, the detection portion 70 can be composed of a laser beam profiler having a CCD (i.e., charge coupled device) camera. In this case, the machining state of the through-hole 51, the intensity of the laser beam 60 and the like are detected by the profiler in real time. Accordingly, even after the through-hole 51 is formed in the through-hole forming process, the focus point 61 of the laser beam 60 can be controlled on the basis of the detection of the laser beam 60 by the detection portion 70.

Thus, the controller 80 controls the voltage applied to the varifocal lens device 20 so that the focus point 61 of the laser beam 60 is displaced a different position automatically. Thus, the shape of the object 50 is reformed appropriately so that the through-hole 51 having high straightness and high accuracy of shape.

Specifically, the equipment 200 can displace the focus point 61 multiple times so that the inner wall of the through-hole 51 becomes much smooth. The accuracy of the shape of the through-hole 51 is much improved.

Although the varifocal system is provided by the detection portion 70 and the controller 80, the varifocal system can be provided by other constructions. For example, in a case where the equipment 200 has no varifocal lens device 20, at least one of the condenser lens 10 and the object 50 is displaced on the basis of the detection of the laser beam 60 by the detection portion 70 so that the focus point 61 is changed.

Such changes and modifications are to be understood as being within the scope of the present invention as defined by the appended claims.

1. A method for machining an object, the method comprising the steps of:
forming a hole in the object by a laser beam in such a manner that the laser beam has a first focus point; and
reforming the hole by the laser beam in such a manner that the laser beam has a second focus point, which is different from the first focus point, wherein,
the first and the second focus points are disposed on a same light axis,
in at least one of the step of forming the hole and the step of reforming the hole, the object is machined by a diffusion and a condensation of the laser beam in the object, and
the condensation is performed by reflection of the laser beam reflected on an inner wall of the hole.

2. The method according to claim 1, wherein
the laser beam is irradiated on the object through a condenser lens, and
the laser beam is controlled by at least one condition among a diameter of the laser beam outputted from the condenser lens, a focal distance between the condenser lens and a focus point of the laser beam, and an energy density of the laser beam.

3. The method according to claim 1, wherein
the hole is machined to have a predetermined shape, which includes a narrow width portion and a wide width portion,
the narrow width portion is formed by the laser beam switching from the condensation to the diffusion,
the wide width portion is formed by the laser beam switching from the diffusion to the condensation, and
the narrow width portion and the wide width portion of the hole are disposed alternately in the object.

4. The method according to claim 1, wherein
in the step of forming the hole, the hole is formed as a through-hole.

5. The method according to claim 1, wherein
the focus point is set to be inside or outside of the object.

6. The method according to claim 1, wherein
in the step of reforming the hole, the hole is reformed multiple times with the laser beam having different focus points, which are different from the first focus point.

7. The method according to claim 1, wherein
in the step of reforming the hole, a focus point of the laser beam is changed by displacing the object and by fixing a focus of the laser beam.

8. The method according to claim 1, wherein
in the step of reforming the hole, a focus point of the laser beam is changed by changing a focus of the laser beam and by fixing a position of the object.

9. The method according to claim 1, wherein
in the step of reforming the hole, the hole is reformed by displacing the focus point of the laser beam and by changing energy density of the laser beam.

10. The method according to claim 1, wherein
the object is made of metallic material.

11. Laser beam machining equipment for forming a through-hole in an object comprising:
a laser beam output device for outputting a laser beam;
a condenser lens for condensing the laser beam on the object; and
a varifocal device for controlling a focus point of the laser beam coaxially, wherein
the varifocal device controls the laser beam to have a predetermined focus point so that a diffusion of the laser beam in the object and a condensation of the laser beam reflected on an inner wall of the through-hole are occurred for machining the through-hole having a predetermined shape, and
the varifocal device is capable of changing the focus point of the laser beam so that the through-hole is reformed.

12. The equipment according to claim 11, further comprising:
a diameter controller for controlling a diameter of the laser beam outputted from the condenser lens; and
an energy density controller for controlling an energy density of the laser beam, wherein
the laser beam is controlled by at least one of the diameter controller, the energy density controller and the varifocal device.

13. The equipment according to claim 11, wherein
the varifocal device controls the focus point of the laser beam to be inside or outside of the object.

14. The equipment according to claim 11, wherein
the varifocal device changes the focus point of the laser beam once for reforming the through-hole.

15. The equipment according to claim 11, wherein
the varifocal device changes the focus point of the laser beam a plurality of times to be different positions for reforming the through-hole.

16. The equipment according to claim 11, wherein
the varifocal device controls the focus point by displacing the object and by fixing a focus of the laser beam.

17. The equipment according to claim 11, wherein
the varifocal device controls the focus point by changing a focus of the laser beam and by fixing a position of the object.

18. The equipment according to claim 11, wherein
the varifocal device is provided by a varifocal lens capable of changing a curvature of the lens, and
the varifocal lens is disposed between the laser beam output device and the condenser lens.

19. The equipment according to claim 11, wherein
the varifocal device controls the focus point by displacing the condenser lens along with the light axis of the laser beam and by fixing a position of the object.

20. The equipment according to claim 11, wherein
the through-hole is reformed by changing the focus point of the laser beam and by changing energy density of the laser beam.

21. The equipment according to claim 11, wherein
the object is made of metallic material.

22. The equipment according to claim 11, further comprising:
a detection portion for detecting the laser beam penetrating the object, wherein
the varifocal device for controlling the focus point of the laser beam coaxially on the basis of a detection signal of the laser beam detected by the detection portion.
